(19) United States
(12) Patent Application Publication
(10) Pub. No.: US 2022/0387154 A1
(43) Pub. Date: Dec. 8, 2022

(54) ORAL IRRIGATOR

(71) Applicant: XIAMEN SOLEX HIGH-TECH INDUSTRIES CO.,LTD., XIAMEN (CN)

(72) Inventors: Shuixiu XIE, Xiamen (CN); Guihua YAN, Xiamen (CN); Tingke LIU, XIAMEN (CN); Mingfu ZHANG, XIAMEN (CN)

(73) Assignee: XIAMEN SOLEX HIGH-TECH INDUSTRIES CO.,LTD., XIAMEN (CN)

(21) Appl. No.: 17/816,735

(22) Filed: Aug. 2, 2022

(30) Foreign Application Priority Data
Jun. 7, 2021 (CN) 202110631746.2

(51) Int. Cl. A61C 17/02

(52) U.S. Cl. CPC A61C 17/02; A61C 17/0202

(57) ABSTRACT

This disclosure provides an oral irrigator including a base, a reservoir, a handle and a starter. The base has a pumping assembly, a controller and a starting part. The reservoir has a storage cavity and is removably connected to the base and communicates the storage cavity with the pumping assembly. The handle is configured to guide fluid from the pumping assembly. The starter is provided on the handle or removably connected to the handle. One of the handle and the starter has a signal processor, and when the starting part is operated, the signal processor may receive a first starting signal and send it to the controller. The pumping assembly, the controller and the starting part are electrically connected, and when the starting part is operated, the controller receives a second starting signal. The controller controls the pumping assembly to work after receiving the first and second starting signals.

### CROSS-REFERENCE TO RELATED APPLICATIONS

This application is based on and claims priority to the Chinese application No. 202110631746.2 filed on Jun. 7, 2021 and entitled “ORAL IRRIGATOR”, the entire contents of which are incorporated herein by reference.

### TECHNICAL FIELD

The present disclosure relates to the technical field of cleaning products, in particular to an oral irrigator.

### BACKGROUND

An oral irrigator is used to clean a user's teeth and gums by injecting pressurized fluid into the user's mouth.

In use, the user may sometimes mistakenly trigger a starting button of the oral irrigator before handing the handle into the mouth to result in splashing water, and further affect the user's experience.

### SUMMARY

Embodiments of the present disclosure provide an oral irrigator that can prevent splashing water due to its double starting function.

The oral irrigator according to the embodiments of the present disclosure includes a base, a reservoir, a handle and a starter. The base is provided with a pumping assembly, a controller and a starting part. The reservoir has a storage cavity. The reservoir is removably connected to the base, so that the storage cavity is communicated with the pumping assembly. The handle is configured to guide fluid from the pumping assembly. The starter is provided on the handle or removably connected to the handle. One of the handle and the starter is provided with a signal processor, and when the starting part is operated, the signal processor may receive a first starting signal and send the first starting signal to the controller. The pumping assembly, the controller and the starting part are electrically connected, and when the starting part is operated, the controller receives a second starting signal. The controller may control the pumping assembly to work after receiving the first starting signal and then receiving the second starting signal.

According to some embodiments of the present disclosure, the signal processor includes a first radio frequency unit, and the controller includes a second radio frequency unit.

The starter is removably connected to the handle, the handle is provided with a first trigger electrically connected with the first radio frequency unit, and the starting part is provided with a second trigger.

The first starting signal is generated when the first trigger and the second trigger contact with each other or a distance between the first trigger and the second trigger is less than or equal to a predetermined distance.

According to some embodiments of the present disclosure, both the first trigger and the second trigger are made of conductive materials, and the first starting signal is generated when the first trigger and the second trigger contact with each other.

According to some embodiments of the present disclosure, a conduit is provided between the starter and the pumping assembly to guide the fluid from the pumping assembly into the starter.

The starter is removably communicated with the handle, so that fluid flowing through the starter flows into the handle.

According to some embodiments of the present disclosure, the handle is provided with a first connecting structure, the starter is provided with a second connecting structure, and the first connecting structure and the second connecting structure are detachably and sealingly connected.

According to some embodiments of the present disclosure, the starter includes a body part and a connecting part, the connecting part is convexly disposed on a side of the body part, and the second connecting structure is disposed on the connecting part.

The first connecting structure is concavely disposed on an end face of the handle.

When the starting part is connected to the handle, the first connecting structure and the second connecting structure are rotatably connected, and the connecting part is accommodated in the handle.

According to some embodiments of the present disclosure, the starter is removably connected to the handle.

An accommodating groove is disposed on a side surface of the base, and the starter is removably disposed in the accommodating groove.

According to some embodiments of the present disclosure, the pumping assembly includes a pump assembly and a motor, the motor is drivingly connected to the pump assembly, and the controller is electrically connected to the motor.

According to some embodiments of the present disclosure, the handle includes a hand-held part and a water outlet part, and the water outlet part is rotatably and/or detachably connected to the hand-held part.

According to some embodiments of the present disclosure, the controller does not control the pumping assembly to work when not receiving the first starting signal but receiving the second starting signal.

Any of the above embodiments of the present disclosure has following advantages or beneficial effects:

According to the oral irrigator of the embodiments of the present disclosure, the starter and the starting part are disposed to respectively generate the first starting signal and the second starting signal, and the pumping assembly works after the controller receives the first starting signal and then receives the second starting signal, so that an effect of double starting may be formed, and thereby effectively solving an problem of splashing water caused by triggering a starting button before the user gets ready.

### BRIEF DESCRIPTION OF THE DRAWINGS

The above and other features and advantages of the present disclosure will become more apparent by describing in detail exemplary embodiments thereof with reference to the accompanying drawings.

FIG. 1 shows a front view of an oral irrigator according to an embodiment of the present disclosure.

FIG. 2 shows a left view of the oral irrigator according to the embodiment of the present disclosure.

FIG. 3 shows a top view of the oral irrigator according to the embodiment of the present disclosure.

FIG. 4 shows an exploded view of the oral irrigator according to the embodiment of the present disclosure.

FIG. 5 shows a schematic view of the oral irrigator according to the embodiment of the present disclosure in which the handle and the starter are not connected.

FIG. 6 shows a schematic view of the oral irrigator according to the embodiment of the present disclosure in which the handle and the starter are connected.

FIG. 7 is a functional block diagram of the oral irrigator according to the embodiment of the present disclosure.

### REFERENCE NUMBERS ARE LISTED AS FOLLOWS

100 Base
110 Pumping Assembly
111 Pump Assembly
112 Motor
120 Controller
121 Second Radio Frequency Unit
122 CPU
130 Starting Part
140 Accommodating Groove
200 Reservoir
300 Handle
301 First Trigger
310 Signal Processor
311 First Radio Frequency Unit
312 CPU
320 Hand-held Part
330 Water Outlet Part
340 Brush Head
350 Inner Core Assembly
400 Starter
401 Second Trigger
410 Body Part
420 Connecting Part
421 Second Connecting Structure
500 Conduit

### DETAILED DESCRIPTION

Example embodiments will now be described more fully with reference to the accompanying drawings. However, exemplary embodiments can be implemented in various forms and should not be understood as being limited to the embodiments set forth herein; on the contrary, these embodiments are provided so that the present disclosure will be thorough and complete, and will fully convey the concept of the exemplary embodiments to those skilled in the art. The same reference numbers in the drawings indicate the same or similar structures, and thus their detailed description will be omitted.

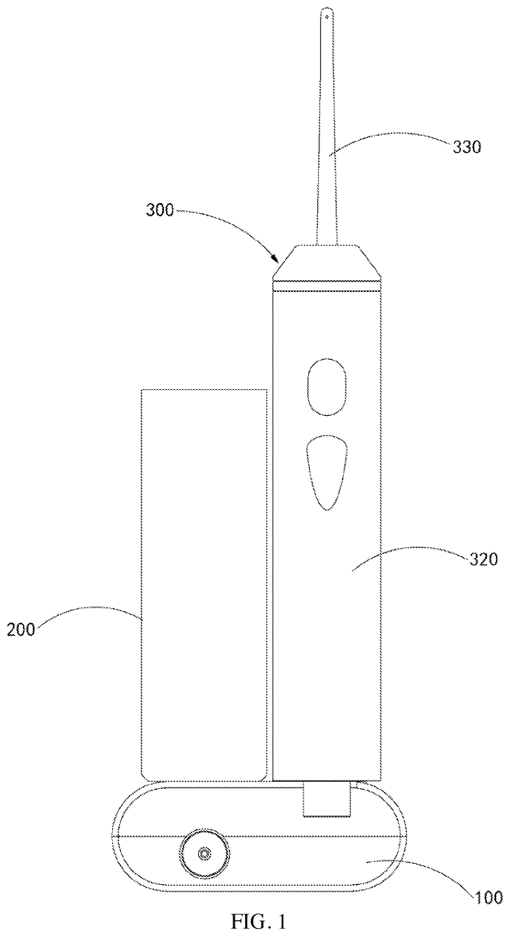

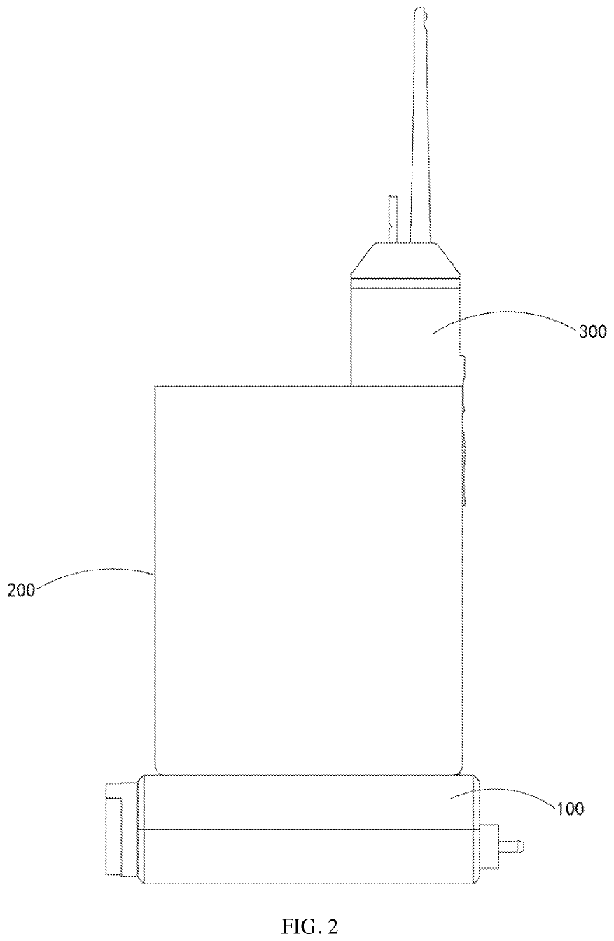

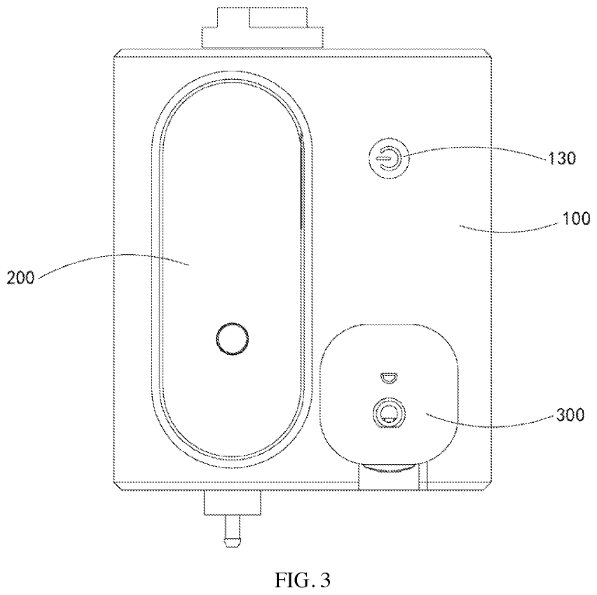

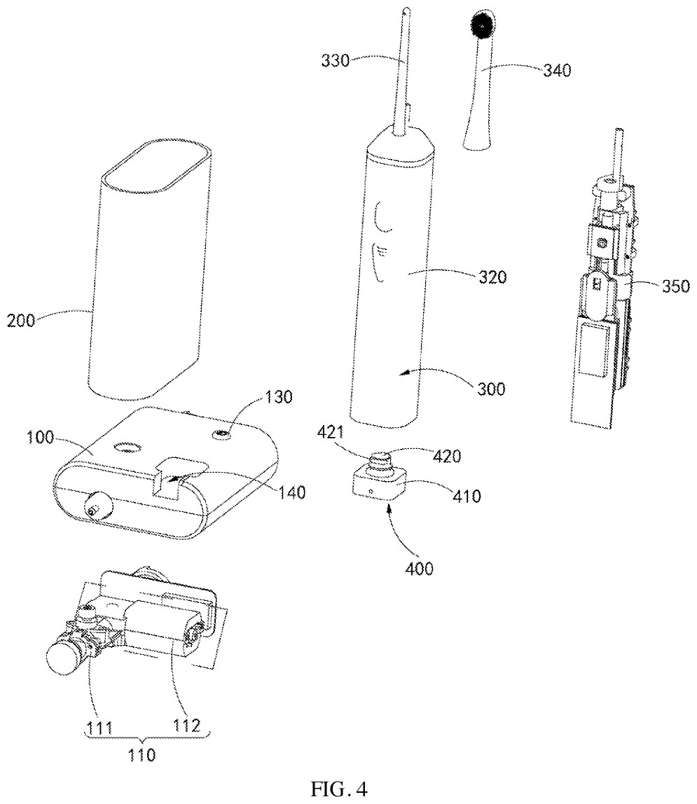

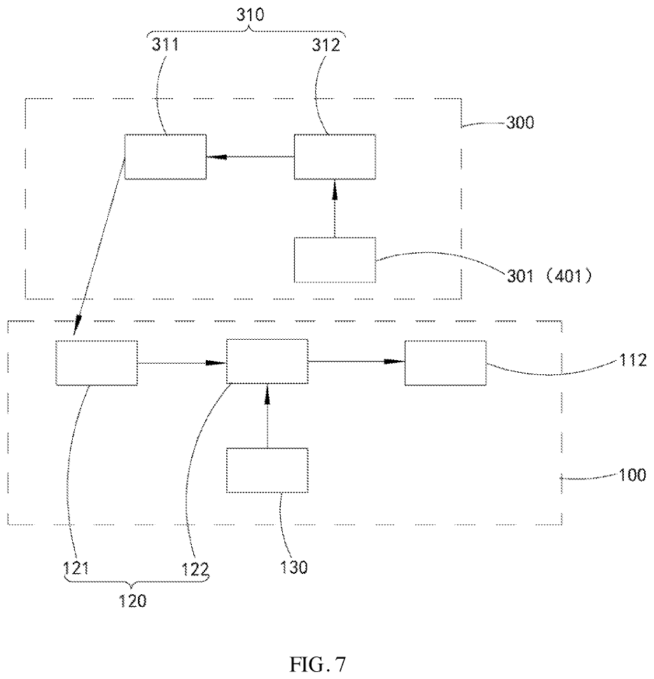

As shown in FIGS. 1 to 4, FIG. 1 shows a front view of an oral irrigator according to an embodiment of the present disclosure, FIG. 2 shows a left view of the oral irrigator according to the embodiment of the present disclosure, FIG. 3 is a top view of the oral irrigator according to the embodiment of the present disclosure, FIG. 4 is an exploded view of the oral irrigator according to the embodiment of the present disclosure. The oral irrigator according to the embodiment of the present disclosure includes a base 100, a reservoir 200, a handle 300 and a starter 400. The base 100 is provided with a pumping assembly 110, a controller 120 (as shown in FIG. 7) and a starting part 130. The reservoir 200 has a storage cavity, and the storage cavity is removably connected to the base 100 and communicates with the pumping assembly 110. The handle 300 is used to guide fluid from the pumping assembly 110. The starter 400 is provided on the handle 300 or removably connected to the handle 300. One of the handle 300 and the starter 400 is provided with a signal processor 310 (as shown in FIG. 7). When the starter 400 is operated, the signal processor 310 may receive a first starting signal, and send the first starting signal to the controller 120. The pumping assembly 110, the controller 120 and the starting part 130 are electrically connected, and when the starting part 130 is operated, the controller 120 receives a second starting signal. The controller 120 can control the pumping assembly 110 to work after receiving the first starting signal and then receiving the second starting signal.

In the embodiment of the present disclosure, in use of the oral irrigator, the starter 400 is first operated such that the signal processor 310 may receive a first starting signal and send the first starting signal to the controller 120. Then, the starting part 130 is operated such that the controller 120 can receive a second starting signal. The controller 120 may control the pumping assembly 110 to work after receiving the first starting signal and then receiving the second starting signal, so that fluid in the reservoir 200 is pumped into the handle 300, finally realizing a function of rinsing teeth and gums of the user.

According to the oral irrigator of the embodiment of the present disclosure, the starter 400 and the starting part 130 are disposed to respectively generate the first starting signal and the second starting signal, and the pumping assembly 110 works when the controller 120 receives the first starting signal and then receives the second starting signal, so that the double starting effect can be formed, which effectively solves the problem of splashing water caused by triggering the starting button before the user gets ready.

As shown in FIG. 4, the pumping assembly 110 includes a pump assembly 111 and a motor 112. The motor 112 is drivingly connected to the pump assembly 111 and the controller 120 is electrically connected to the motor 112. When the reservoir 200 is connected to the base 100, the pump assembly 111 communicates with the storage cavity of the reservoir 200, so that the fluid in the reservoir chamber can be pumped out when the pump assembly 111 works.

It could be understood that the fluid in the reservoir 200 may be water, mouthwash or other liquid suitable for oral cleaning.

The reservoir 200 according to the embodiment of the present disclosure is removably connected to the base 100. When the fluid in the reservoir 200 is used up, the reservoir 200 may be removed from the base 100 to perform a function of replenishing the fluid in time.

The handle 300 includes a hand-held part 320, a water outlet part 330, a brush head 340 and an inner core assembly 350. The water outlet part 330 is rotatably and/or detachably connected to the hand-held part 320. For example, the water outlet part 330 is rotatably connected to the hand-held part 320; or alternatively, the water outlet part 330 is detachably connected to the hand-held part 320; or alternatively, the water outlet part 330 is rotatably and detachably connected to the hand-held part 320.

The water outlet part 330 is rotatably connected to the hand-held part 320, so that the water outlet part 330 can be rotated by 360 degrees to clean the oral cavity of the user in all directions. The water outlet part 330 is detachably connected to the hand-held part 320, so that the water outlet part 330 can be replaced at any time.

The brush head 340 is sleeved outside the water outlet part 330, so that the function of brushing the oral cavity can be achieved.

It should be noted that the brush head 340 may be separately installed on a driving shaft of the hand-held part 320 without installing the water outlet part 330, so that the handle 300 can be used as an electric toothbrush.

The inner core assembly 350 is received in the hand-held part 320, which can realize functions such as suspending and adjusting the strength of pulse water, for example. It should be noted that the specific structure of the inner core assembly 350 may adopt a mature scheme in the prior art, which will not be repeated herein.

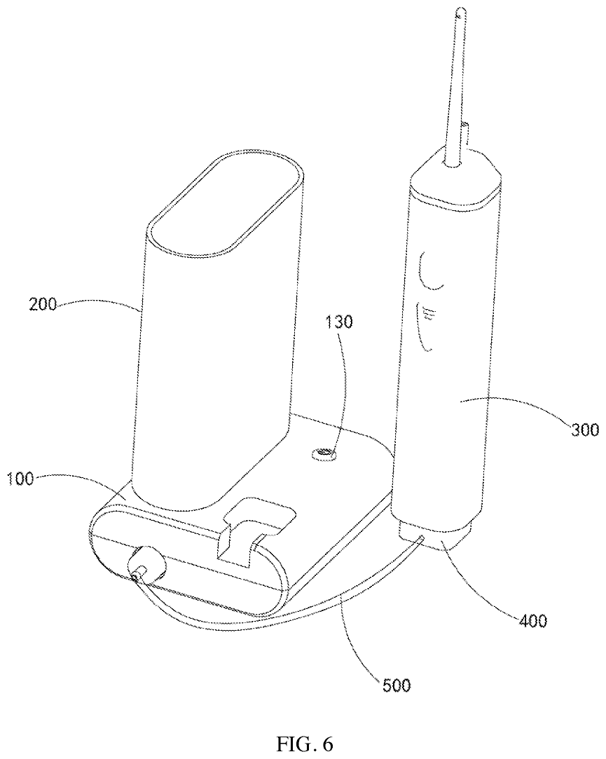

As shown in FIGS. 4 to 7, FIG. 5 is a schematic view of the oral irrigator according to the embodiment of the present disclosure in which the handle and the starter are not connected, FIG. 6 shows a schematic view of the oral irrigator according to the embodiment of the present disclosure in which the handle and the starter are connected, and FIG. 7 is a functional block diagram of the oral irrigator according to the embodiment of the present disclosure. The starter 400 is removably connected to the handle 300. The signal processor 310 may generate a first starting signal when the starter 400 is connected to the handle 300; and the signal processor 310 cannot generate the first starting signal when the starter 400 is separated from the handle 300.

Specifically, the signal processor 310 may include a first radio frequency unit 311 and a central processing unit (CPU) 312, and the controller 120 may include a second radio frequency unit 121 and a CPU 122. The handle 300 is provided with a first trigger 301 that is electrically connected with the first radio frequency unit 311, and the starter 400 is provided with a second trigger 401. The first starting signal is generated when the first trigger 301 and the second trigger 401 contact with each other or a distance between the first trigger and the second trigger is less than or equal to a predetermined distance.

The CPU 312 controls the first radio frequency unit 311 to send the generated first starting signal to the second radio frequency unit 121 when the first trigger 301 and the second trigger 401 contact with each other, so that the CPU 122 can control the motor 112 to work.

In an embodiment, both the first trigger 301 and the second trigger 401 are made of conductive materials, and the first starting signal is generated when the first trigger 301 and the second trigger 401 contact with each other.

In this embodiment, it is specifically defined that the first starting signal is triggered by a conductive contact between the first trigger 301 and the second trigger 401.

However, it can be understood that a proximity switch may also be used for the first trigger 301 and the second trigger 401, for example, one of the first trigger 301 and the second trigger 401 is a proximity switch, and the other of the first trigger 301 and the second trigger 401 is a metal piece. The first starting signal may also be generated when the starter 400 and the handle 300 approach to each other and a distance between the first trigger 301 and the second trigger 401 is less than or equal to a predetermined distance. It should be noted that the specific value of the predetermined distance can be adaptively designed by an ordinary skilled person in the art according to a size of the product and a model of the proximity switch, which is not particularly limited in the present disclosure.

However, a signal transmission mode between the signal processor 310 and the controller 120 is not limited to a mode of using radio frequency, for example, Bluetooth, infrared, or other suitable wireless transmission modes may also be used.

In addition, it should be noted that the starter 400 and the handle 300 are removably connected in the embodiment as mentioned above. However, the starter 400 may also be provided on the handle 300. For example, the starter 400 may be a starting button, and is electrically connected to the signal processor 310. The signal processor 310 may also generate the first starting signal when the user operates the starting button.

However, it can be understood that the signal processor 310 may be disposed on one of the handle 300 and the starter 400. For example, the signal processor 310 is provided inside the handle 300 or the starter 400.

As shown in FIGS. 4 to 6, a conduit 500 is provided between the starter 400 and the pumping assembly 110 to guide the fluid from the pumping assembly 110 into the starter 400. The starter 400 is removably communicated with the handle 300, so that the fluid flowing through the starter 400 can flow into the handle 300.

In this embodiment, it is specifically defined that the starter 400 also has the function of fluid circulation. Specifically, the starter 400 may also have a flow channel. One end of the flow channel is communicated with the pumping assembly 110 through the conduit 500, and the other end of the flow channel is communicated with the handle 300.

When the pumping assembly 110 is in operation, the fluid in the reservoir 200 may sequentially flow through the pumping assembly 110, the conduit 500, the starter 400 and the handle 300, and finally be ejected from the water outlet part 330. In other words, the starter 400 can not only trigger the first starting signal, but also be used as a flow channel for conveying fluid.

As shown in FIG. 4, the handle 300 is provided with a first connecting structure, the starter 400 is provided with a second connecting structure 421, and the first connecting structure and the second connecting structure are detachably and sealingly connected. In this way, when the starter 400 is used as a flow channel for conveying fluid, the fluid will not leak from a connection between the starter 400 and the handle 300.

The starter 400 includes a body part 410 and a connecting part 420 convexly disposed on a side of the body part 410. The second connecting structure 421 is disposed on the connecting part 420, and the first connecting structure is concavely disposed on an end face of the handle 300. When the starter 400 is connected to the handle 300, the first connecting structure and the second connecting structure 421 are rotatably connected, and the connecting part 420 is accommodated in the handle 300.

As an example, the first connecting structure may be concavely disposed on a bottom surface of the handle 300. The connecting part 420 can be inserted into the bottom of the handle 300 when the starter 400 is connected to the handle 300.

It should be noted that a detachable connecting structure in the prior art may also be used for the first connecting structure and the second connecting structure, which is not particularly limited in the present disclosure. As for sealing connection, a structural sealing or a sealing ring may also be used.

However, it can be understood that a flow passage for conveying the fluid to the handle 300 may be directly connected to the handle 300 through the conduit 500 without passing through the starter 400.

Referring to FIG. 4, an accommodating groove 140 is provided on a side surface of the base 100, and the starter 400 is removably disposed in the accommodating groove 140.

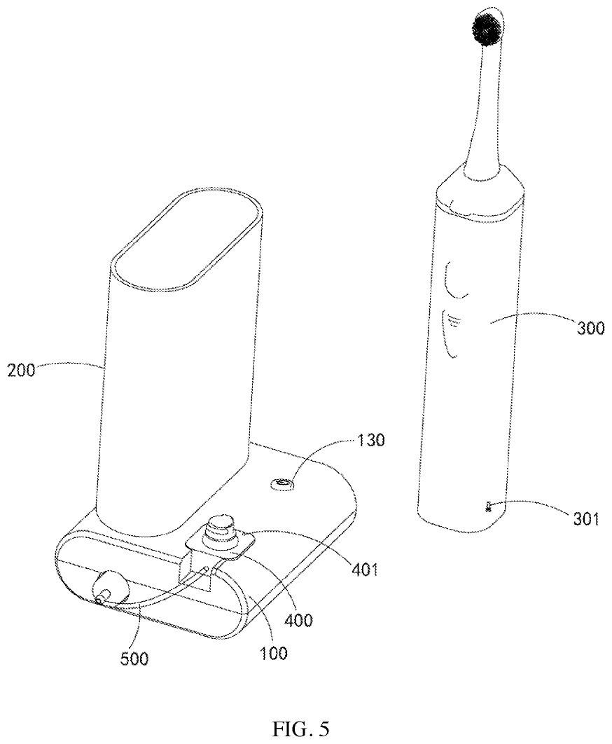

As shown in FIG. 5, the starter 400 is disposed in the accommodating groove 140, and is not connected to the handle 300. At this time, if the user presses the starting part 130, the signal processor 310 of the handle 300 will not generate the first starting signal although the controller 120 can receive the second starting signal. Thus, the pumping assembly 110 is not controlled to work by pressing the starting part 130, that is, water will not be discharged from the handle 300.

As shown in FIG. 6, the starter 400 is connected to the handle 300, that is, the first trigger 301 and the second trigger 401 contact with each other, and the signal processor 310 generates a first starting signal and sends the first starting signal to the controller 120. At this time, if the user presses the starting part 130, the controller 120 receives the second starting signal after receiving the first starting signal, so that the pumping assembly 110 works and water is discharged from the handle 300.

As mentioned above, the advantages and benefits of the oral irrigator according to the embodiment of the present disclosure are as follows:

As for the oral irrigator of the embodiment of the present disclosure, the starter 400 and the starting part 130 are disposed to respectively generate the first starting signal and the second starting signal, and the pumping assembly 110 works when the controller 120 receives the first starting signal and then receives the second starting signal, so that the double starting effect can be formed, which effectively solves the problem of splashing water caused by mistakenly triggering the starting button when the user does not get ready.

In the embodiments of the present disclosure, the terms “first”, “second” and “third” are only intended to describe objectives of the present disclosure, and cannot be understood as indicating or implying relative importance. The expression “a plurality” refers to two or more, unless otherwise explicitly defined. The terms “install”, “inter-connect”, “connect” and “fixed” or the like should be understood broadly. For example, “connect” may mean a fixed connection, a detachable connection, or an integral connection. The term “inter-connect” may mean a directly connection or indirectly connection through an intermediate element. For the skilled person in the art, the specific meanings of the above terms in the embodiments of the present disclosure can be understood according to specific situations.

According to the description of the embodiments of the present disclosure, it should be understood that the directions or positional relationships indicated by the terms “up”, “down”, “left”, “right”, “front”, “back” and the like are based on the directions or positional relationships shown in the drawings, only for the convenience of describing and simplifying the embodiments of the present disclosure, instead of indicating or implying that the referred devices or units must have a specific direction, be constructed and operated in a specific direction. Therefore, it cannot be understood as limitation to the present disclosure.

According to the description of this specification, the terms “an embodiment”, “some embodiments” and “specific embodiments” means that the specific features, structures, materials or characteristics described in connection with this embodiment or example are included in at least one embodiment or example of the present disclosure. In this specification, the schematic expressions of the above terms do not necessarily refer to the same embodiment or example. Furthermore, the specific features, structures, materials or characteristics described may be combined in any one or more embodiments or examples in a suitable manner.

The above are only preferred embodiments of the embodiments of the present disclosure, and are not intended to limit the embodiments. For the skilled person in the art, the embodiments may have various modifications and changes, and any modifications, equivalent substitutions, improvements, etc. made within spirit and principle of the embodiment of the present disclosure shall be included in the protection scope of the embodiments of the present disclosure.

What is claimed is:

1. An oral irrigator, comprising:
a base (100) provided with a pumping assembly (110), a controller (120) and an starting part (130);
a reservoir (200) having a storage cavity, wherein the reservoir (200) is removably connected to the base (100) and communicates the storage cavity with the pumping assembly (110);
a handle (300) for guiding fluid from the pumping assembly (110); and
a starter (400) provided on the handle (300) or removably connected to the handle (300);
wherein one of the handle (300) and the starter (400) is provided with a signal processor (310), and when the starter (400) is operated, the signal processor (310) is configured to receive a first starting signal and send the first starting signal to the controller (120);
wherein the pumping assembly (110), the controller (120), and the starting part (130) are electrically connected, and when the starting part (130) is operated, the controller (120) receives a second starting signal; and
wherein the controller (120) is configured to control the pumping assembly (110) to work after receiving the first starting signal and then receiving the second starting signal.

2. The oral irrigator according to claim 1, wherein the signal processor (310) comprises a first radio frequency unit (311), and the controller (120) comprises a second radio frequency unit (121);
the starter (400) is removably connected to the handle (300), the handle (300) is provided with a first trigger (301) electrically connected with the first radio frequency unit (311), and the starter (400) is provided with a second trigger (401);
the first starting signal is generated when the first trigger (301) and the second trigger (401) contact with each other or a distance between the first trigger (301) and the second trigger (401) is less than or equal to a predetermined distance.

3. The oral irrigator according to claim 2, wherein both the first trigger (301) and the second trigger (401) are made of conductive materials, and the first starting signal is generated when the first trigger (301) and the second trigger (401) contact with each other.

4. The oral irrigator according to claim 2, wherein a conduit (500) is provided between the starter (400) and the pumping assembly (110) to guide the fluid from the pumping assembly (110) into the starter (400);
the starter (400) is removably communicated with the handle (300), so that fluid flowing through the starter (400) slows into the handle (300).

5. The oral irrigator according to claim 4, wherein the handle (300) is provided with a first connecting structure, the starter (400) is provided with a second connecting structure, and the first connecting structure and the second connecting structure are detachably and sealingly connected.

6. The oral irrigator according to claim 5, wherein the starter (400) comprises a body part (410) and a connecting part (420), the connecting part (420) is convexly disposed on a side of the body part (410), and the second connecting structure is disposed on the connecting part (420);
the first connecting structure is concavely disposed on an end face of the handle (300);
when the starter (400) is connected to the handle (300), the first connecting structure and the second connecting structure are rotatably connected, and the connecting part (420) is accommodated in the handle (300).

7. The oral irrigator according to claim 1, wherein the starter (400) is removably connected to the handle (300);
an accommodating groove (140) is disposed on a side surface of the base (100), and the starter (400) is removably disposed in the accommodating groove (140).

8. The oral irrigator according to claim 1, wherein the pumping assembly (110) comprises a pump assembly (111) and a motor (112), the motor (112) is drivingly connected to the pump assembly (111), and the controller (120) is electrically connected to the motor (112).

9. The oral irrigator according to claim 1, wherein the handle (300) comprises a hand-held part (320) and a water outlet part (330) rotatably and/or detachably connected to the hand-held part (320).

10. The oral irrigator according to claim 1, wherein the controller (120) does not control the pumping assembly (110) to work when not receiving the first starting signal but receiving the second starting signal.
